(19) United States
(12) Patent Application Publication
(10) Pub. No.: US 2024/0062514 A1
(43) Pub. Date: Feb. 22, 2024

(54) DIVERSITY QUANTIFICATION

(71) Applicant: X Development LLC, Mountain View, CA (US)

(72) Inventors: Julia Black Ling, Menlo Park, CA (US); Cory Drew Schillaci, Berkeley, CA (US); Yangli Hector Yee, San Francisco, CA (US); Grace Calvert Young, Mountain View, CA (US); Karan Jhavar, Sunnyvale, CA (US)

(21) Appl. No.: 18/452,379

(22) Filed: Aug. 18, 2023

Related U.S. Application Data
(60) Provisional application No. 63/399,431, filed on Aug. 19, 2022.

(51) Int. Cl. G06V 10/762; G06V 10/764; G06V 10/82; G06V 10/58; G06V 40/10; G06V 20/56; G06V 20/05

(52) U.S. Cl. CPC G06V 10/763; G06V 10/764; G06V 10/82; G06V 10/58; G06V 40/10; G06V 20/56; G06V 20/05

(57) ABSTRACT

Methods, systems, and apparatus, including computer programs encoded on computer storage media, for Measuring and Quantifying Biodiversity in an Environment. One of the methods includes receiving a set of images representing the marine environment; identifying, by one or more processing devices within the set of images, objects representing marine life in the marine environment; classifying, by the one or more processing devices, the objects into multiple clusters based on feature vectors identified for each of the objects; and computing, by the one or more processing devices based on attributes associated with the multiple clusters, a metric indicative of the biodiversity in the marine environment.

### CROSS-REFERENCE TO RELATED APPLICATION

This application claims the benefit of U.S. Provisional Application No. 63/399,431, filed Aug. 19, 2022, the contents of which are incorporated by reference herein.

### BACKGROUND

Discerning the diversity of a group of objects can be labor intensive and slow. Whether quantifying the diversity of vehicles on the road or trees in a forest, the process can be prone to error and the results are often subjective.

### SUMMARY

In general, one aspect of the subject matter described in this specification can be embodied in methods that include the actions of receiving a set of images representing the marine environment; identifying, by one or more processing devices within the set of images, objects representing marine life in the marine environment; classifying, by the one or more processing devices, the objects into multiple clusters based on feature vectors identified for each of the objects; and computing, by the one or more processing devices based on attributes associated with the multiple clusters, a metric indicative of the biodiversity in the marine environment.

Other implementations of this aspect include corresponding computer systems, apparatus, computer program products, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other implementations can each optionally include one or more of the following features, alone or in combination.

In some implementations, the set of images include images captured by a remotely operated vehicle.

In some implementations, the set of images include hyperspectral images.

In some implementations, the feature vectors include vectors of locally aggregated descriptors (VLADs) generated by processing representation of the objects by a convolutional neural network.

In some implementations, the attributes associated with the multiple clusters include one or more of: a number of clusters, a distribution of the multiple clusters, a spread among the multiple clusters, and a spread within a particular cluster of the multiple clusters.

In some implementations, the objects are classified into multiple clusters using a supervised machine learning model trained on a corpus of labeled data set identifying various forms of marine life.

In some implementations, the metric represents differences among the multiple clusters as computed based on multiple dimensions within the feature vectors.

The subject matter described in this specification can be implemented in various implementations and may result in one or more of the following advantages. The extent of diversity in a marine setting may be determined efficiently, with little to no human intervention. The technology can provide a high level of accuracy by distinguishing between objects in the environment, for example, via the use of accurately determined feature vectors. For example, the system can determine whether an individual fish has already been counted and categorized by the system to a potentially higher degree of accuracy than a person could. For example, the system can improve generalizability between different marine environments with different species of fish present. For example, rather than having the system train a new model for each new individual species (e.g., each species of butterfly fish), it enables the use of a broader model (e.g., fish detection) in combination with unsupervised clustering approaches. In some examples, the system can reduce the effort for labeling images. For example, well refined labelers (e.g., trained labeling engines) can label a single subset of images in a cluster instead of every image in a cluster. In this example, the system saves time and resources labeling clusters rather than images.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 an example of a diversity quantification system 100 that can be configured to execute a biodiversity metric calculation process described herein.

FIG. 2 is a similar example of the system of FIG. 1 that includes receiving images, detecting objects in the received images, clustering the detections into clusters, and labeling the clusters.

FIG. 3 is a flow diagram of an example process 300 for the diversity quantification process.

FIG. 4 is a block diagram of a computing system that can be used in connection with computer-implemented methods described in this specification.

Like reference numbers and designations in the various drawings indicate like elements.

### DETAILED DESCRIPTION

When the diversity within a system is measured, one approach involves the identification of objects within that system, then the binning or grouping of those identified objects into sections, then more subjective measures analyze the sections to determine the diversity overall.

For example, measuring and quantifying biodiversity in a marine environment can be time consuming and difficult. Some processes use manual surveys involving individuals in the field, counting the number of different species or habitats in a given location. Alternatively, sometimes a remotely operated vehicle (ROV) is used, and the footage is analyzed manually to count species. Or aerial vehicles can quantify biodiversity using hyperspectral imagery. Or environmental DNA (eDNA) methods can quantify biodiversity and are particularly well-suited for underwater environments.

An implementation can use machine learning to speed up the categorization of objects into types. For instance, a system can use a camera and machine learning based methods. In these approaches, one or more cameras or other sensors are used to collect data in one or more locations. This data can then be examined by a classification algorithm such as a convolutional neural network (CNN) that can be trained to label one or more of the species or categories of species, such as genus, in the footage.

However, this approach can have its own challenges and limitations. In environments with hundreds or thousands of species, many of which look similar to each other, collecting and labeling images to train a machine learning model can be extremely time consuming. Furthermore, machine learning models can struggle to generalize well to other systems, which might have different objects present, or the same objects with different appearances.

This specification describes a diversity quantification system that can overcome some disadvantages and can measure the diversity in a system without the need to identify individual objects. The system can cluster the objects and can measure the difference between the clusters as a measurement of diversity. A high number of clusters can indicate a high degree of diversity, and vice versa.

The diversity quantification system can use an object detection system, e.g., one that is based on a neural network, to identify one or more objects in one or more images. For example, a camera can capture footage at a coral reef. The footage can be analyzed by the system and the types of marine life can be clustered into groups. In some implementations, the system can be configured to identify species, and can match the fish based off of similarities.

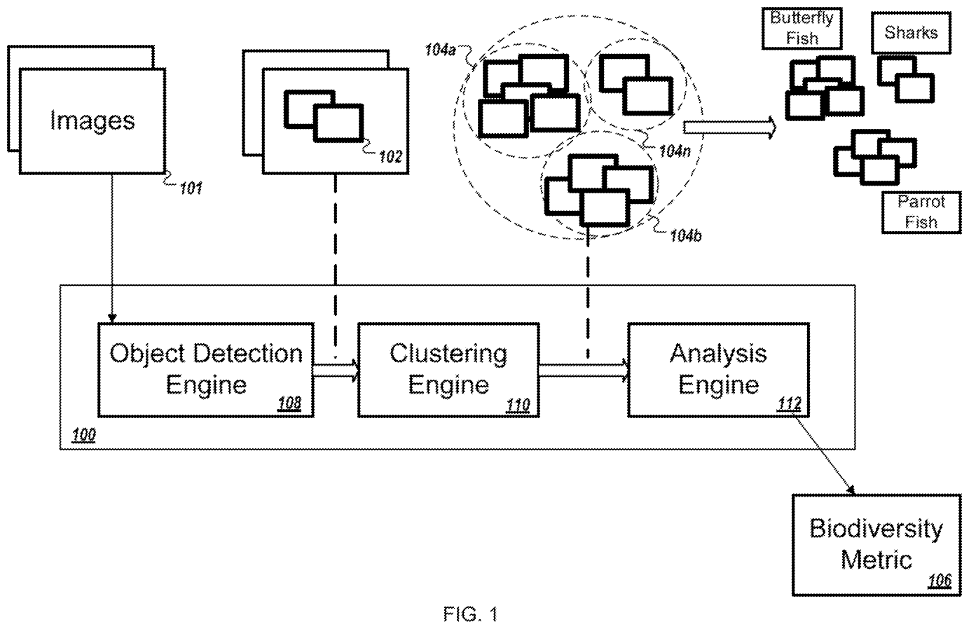

FIG. 1 is an example of a diversity quantification system 100 that can be configured to execute a biodiversity metric calculation process described herein. In some implementations, such a process includes receiving images 101, detecting objects 102 in the received images, grouping detected objects into clusters 104, performing a statistical analysis on the grouped clusters, and generating a biodiversity metric 106 based on the statistical assessment. While FIG. 1 shows a particular order of discrete operations, in some implementations, portions of the operations may not be needed, or may be merged with one another. For example, a diversity quantification system can receive images in which objects have already been clustered and the system can be configured determine the diversity of the clusters without having to execute an object detection process. For instance, the measure of diversity can apply to a single grouped cluster, the measure of diversity between clusters, the measure of diversity of all clusters within an environment, or any combination thereof.

In some implementations, the diversity quantification system 100 includes an object detection engine 108 that receives a set of images 101 and detects objects 102 within the image. Object detection may be performed on various types of images including still images, video, scanned images, etc. The object detection can be performed on an entire image or only a portion of the image. The object detection engine 108 can be configured to recognize multiple objects within a single image. The object detection engine 108 can one or more technologies, including, for example, artificial intelligence, neural networks, machine learning, or image processing. In some examples, the object detection engine 108 can be configured to partition an image into portions where objects are detected. For example, in case of an image of a coral reef with multiple fish, the object detection engine 108 can be configured to recognize and crop portions of the original image to create multiple sub-images from a single image.

In some implementations, the diversity quantification system 100 includes a clustering engine 110 that analyzes the object detection results to group together objects determined to be similar into clusters 104. The clustering engine 110 can utilize various techniques including, for example, artificial intelligence, neural networks, machine learning, or image-processing-based techniques. In some implementations, the clustering engine 110 can group similar objects into clusters at various levels of granularity. For example, the clustering engine 110 can be configured to cluster repeated instances of the same exact shark, images of any type of shark, or images of a particular species of shark. The clusters and granularities of clustering categories can be user-defined or determined through automated methods.

In some implementations, the diversity quantification system 100 includes an analysis engine 112 that can be configured to perform, for example, statistical analyses on the output of the clustering engine 110. The statistical assessment can use the clusters generated by the clustering engine 110 and perform statistical analysis on the grouped clusters. The statistical assessment can include further refining the clusters generated by the clustering engine 110, or can perform analysis on the clusters without altering the clusters. The analysis engine can be configured to operate, for example, based on various user-defined parameters, and/or information retrieved from various sources. For instance, a user can define parameters that define a time frame in which to compare the information—such as comparing the number of sharks in a particular area over the last decade. In this instance each cluster would be a season and each season could have a biodiversity metric. The biodiversity metric from each season can then be compared over the decade to identify trend lines. Further user input could then alter the settings to distinguish male from female sharks and determine whether observing subcategories affects the biodiversity metric. For example, the statistical analysis can use additional information from historical records to perform statistical analysis on the cluster of detected objects. For example, the statistical analysis can draw from historical records of the number of sharks in an area, and the ratio of male to female sharks. The historical records can contain statistical information that can overlay or affect the biodiversity metric to show changes over time in various parameters. The user can define these parameters such that the biodiversity metric outputs specific, user-defined metrics about the biodiversity of the area.

In some implementation, the diversity quantification system 100 can utilize data from one or more sources. For example, the diversity quantification system 100 can use images collected from a single camera station, an ROV, or multiple camera stations. The biodiversity metric 106 can refer to a specific location or can be interpolated across a region.

In some implementation, the diversity quantification system 100 can utilize one or more data types or sources in order to output one or more diversity genres. For instance, a biodiversity metric 106 can assess the impact of a single variable in a marine diversity measurement, or can combine with other data, such as water quality, air quality, sediment data, to determine an overall ecological health score of the marine environment.

The various data types and sources can be used to contextualize the diversity metrics. For example, the diversity quantification system 100 can be configured to measure the diversity of fish in a marine environment with respect to water temperature or other variables. Other variables can include but are not limited to location, time, water depth, salinity, current, weather, available light, or any combination thereof.

The combination of data types and sources can allow for the presentation of multiple data sets for analysis. The analysis can reveal information about supporting factors or variables that affect the diversity in a system. For instance, a multi-variable representation of the diversity in a system can aid in part of a calculation to determine total carbon sequestration within an ecosystem. In some instances, the data is combined with historical data or theoretical models.

In some implementation, the diversity quantification system 100 can account for different aspect angles of objects. For example, if an image of a fish is captured at a head-on angle, rather than a profile image, the system can account for the aspect angle in the data set.

In some implementation, the diversity quantification system 100 can include an audit of the data at the end of a collection. The audit can trigger based off of the system identifying some clusters that need verification. For instance, the system can have low confidence on two clusters and present them to the user for verification. The user can verify the cluster or discard it from the data set.

In some implementation, the diversity quantification system 100 can use an unsupervised learning approach to generate clusters within the objects. The diversity quantification system 100 can use feature vectors generated by CNNs, e.g., using vector of locally aggregated descriptor (VLAD) or other approaches. For example, the unsupervised learning can use k-means clustering or other clustering algorithms. For instance, a particular fish living at a coral reef will have a particular feature vector generated to represent what the CNN has identified as a fish. Again, the species does not matter, just that it is a fish. The fish that are identified with similar feature vectors can be clumped together in clusters.

The analysis engine 112 can be configured to generate a biodiversity metric 106 that represents the diversity of the objects detected. For example, the biodiversity metric can represent one of: a number of sharks in an environment during a season, the number of times a particular species of shark was in an area, or the number of times a specific identifiable shark entered an area. In some implementations, the biodiversity metric 106 can represent time series data. For instance, the biodiversity metric can represent the total number of a particular type of fish at various times of day, month, year, season, etc. The biodiversity metric 106 can be represented using numerical, graphical, visual, or other forms of representation.

In some implementation, the diversity quantification system 100 can include an analysis engine 112 that is configured to perform a statistical assessment of the diversity based on the number of clusters, distribution between clusters, spread between clusters, and spread within a given cluster. For example, once all of the clusters of different feature vectors of fish are categorized the system can analyze the distance between these feature vectors and can use that distance as a measure of diversity.

The statistical assessment of diversity can include several methods of processing the data. For instance, the silhouette coefficient or Dunn index of the clustering are examples of potential options for this statistical assessment. The statistical analysis can take into account, for example, the size of clusters, the one or more measurable differences between clusters in all the dimensions contained within a feature vector, or any combination thereof.

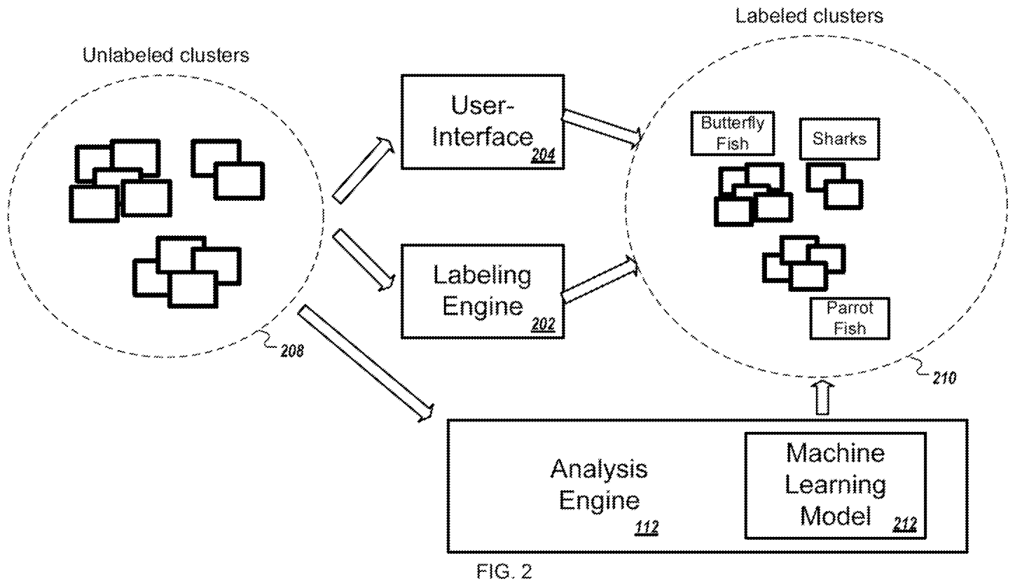

FIG. 2 is an example of various methods of labeling the clusters. For instance, the unlabeled clusters 208 can be labeled into labeled clusters 210 through various methods or combinations of method included labeling engine 202, user interface 204, or the analysis engine 112 with a machine learning model 212. A labeling engine 202 can use a machine learning model 212 or other technologies, including, for example, artificial intelligence, neural networks, or other equivalent methods to determine the labeling of clusters. In some instances, objects detected within clusters can be specifically identified. For example, a historical or stored images of a particular shark can be used to identify that specific shark in the clustering. In this example, the system can recognize the patterns on the shark and/or features on that shark that uniquely identify the shark.

The diversity quantification system 100 can use a labeled cluster 210 to generate the diversity metric 106. In some instances, a user is able to view the labeled clusters 210 and verify the individual objects within the cluster. In some instances, the user can alter the assignment of objects to a cluster. In some instances, the diversity quantification system 100 can reexamine the clusters to verify the correct sorting of objects.

In some instances, a user interface 204 can be provided by the diversity quantification system 100 to allow for manual labeling of the unlabeled clusters 208. The user interface 204 can also be used to label the individual objects within the cluster. In some implementations, the labeling can be used to identify biodiversity within the group of clusters or an individual cluster over time. For example, a physical group of sharks can add or lose members from the group of sharks through the generation of offspring or through loss of sharks to other predators. In this example, the system can recognize both the change in the number of sharks and specifically which sharks are new to the group. The diversity quantification system 100 can determine a change in biodiversity and specifically allow for labeling the cluster and subsets in the cluster to aid in identifying the change in biodiversity.

In some examples, the unlabeled clusters 208 are partially labeled automatically by the labeling engine 202. If the labeling engine is unable to label some grouped clusters, the diversity quantification system 100 can prompt the user for input, search other databases of labeling, or both. The prompt can focus on labeling individual objects in the cluster or on labeling each cluster. The system can use the responses from the prompts to improve the labeling engine. In some instances, the user interface 204 can interact with the labeling of clusters without a prompt. For example, a user can use the user interface to relabel a group previously labeled by the labeling engine.

In some implementations, the diversity quantification system 100 can present to the user through a user interface 204, a set of representative examples from each cluster that the user can label. In this case, the user can provide labels for a small number of images or the number of clusters, rather than the entire image data set. This approach can be used to bootstrap a training data set for an object classification system or to help operators quickly determine what types of objects are present in their images. It can be used as the labels for a semi-supervised classification approach.

In some instances, the diversity quantification system 100 can reorder the clusters based on the desired output metrics. For instance, based on user input the system can combine several clusters of different shark species into a single cluster. In other instances, the system can leave the clusters uncombined and subcategorize the individual shark species under a larger cluster of all sharks. In some examples, the clustering and sub-clustering is done automatically by the system.

In any of the above steps, the diversity quantification system 100 can recognize an error either through an automated process or through user intervention. The error can then be corrected either through user input or reprocessing the image and clustering, recognizing, or labelling it correctly. In some instances, the diversity quantification system 100 can present to a user several images for analysis and use the input form the user to improve the system.

In some implementation, the diversity quantification system 100 can use an unsupervised learning approach. This learning approach can have no need for labeling entire training data set with individual objects. For example, a diversity measurement based on an unsupervised learning approach may not require the fish to be identified by species. For instance, three different color fish can be clustered based off of color alone.

In some implementations, the unsupervised learning approach can allow the diversity quantification system 100 to be deployed in various environments. In some implementation, the diversity quantification system 100 can be deployed in a new environment without the need to generate a new labeled training set. For example, if the diversity quantification system 100 is deployed to analyze a different part of the ocean, no recalibration may be needed to identify fish that inhabit that part of the ocean.

In some implementations, the diversity quantification system 100 can be configured to quantify and correct for sampling effort. For instance, many species richness measures suffer from the problem that they can be strongly dependent on sampling effort. The greater the sampling effort, potentially the higher the index value. This can make it hard to compare biodiversity between different surveys.

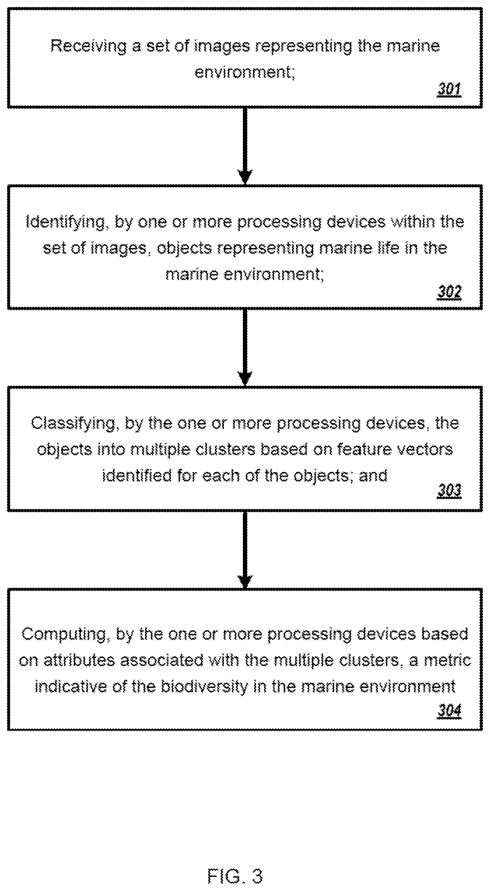

FIG. 3 is a flow diagram of an example process 300 for the diversity quantification process. For example, the process 300 can be used by the diversity quantification process from FIG. 1. The process 300 can include receiving a set of images representing the marine environment 301, identifying, by one or more processing devices within the set of images, objects representing marine life in the marine environment 302, classifying, by the one or more processing devices, the objects into multiple clusters based on feature vectors identified for each of the objects 303, and computing, by the one or more processing devices based on attributes associated with the multiple clusters, a metric indicative of the biodiversity in the marine environment 304.

The process 300 can include receiving a set of images representing the marine environment 301. Images can be obtained from several sources including real time video, still images, historical images or video, or other suitable mediums. The environment is not limited to a marine environment, but can be any environment. For example, the diversity quantification system 100 can receive images representing a rainforest, city, savannah, or any suitable environment for which a diverse number of objects exists. The images received can include hyperspectral images, RADAR or LIDAR images, thermal images, black and white images, or any applicable type of image.

The process 300 can include identifying, by one or more processing devices within the set of images, objects representing marine life in the marine environment 302. For example, the diversity quantification system 100 can receive the set of images in real time from a video camera at a coral reef. The system can process the image frames in the video such that objects are recognized in the images. In this example, the object recognition performed on the images can recognize a plurality of fish in the environment. In other environments the system can recognize butterflies, insects, or any suitable object based on the environment.

The process 300 can include classifying, by the one or more processing devices, the objects into multiple clusters based on feature vectors identified for each of the objects 303. For example, with several objects recognized in an image, the diversity quantification system 100 can then determine that similar objects should be clustered together based on several factors. In some instances, the system used feature vectors as only a portion of the recognition process and used other appropriate object recognition processed to cluster similar objects from an image.

The process 300 can include computing, by the one or more processing devices based on attributes associated with the multiple clusters, a metric indicative of the biodiversity in the marine environment 304. For example, the diversity quantification system 100 can determine that although a dozen fish are detected in the image, there are only three types of fish present. In this example, the diversity metric is three. In some examples, the diversity measurement can represent the ratio of male to female fish within a species.

In some implementations, the process 300 can include additional operations, fewer operations, or some of the operations can be divided into multiple operations. For example, the identifying, by one or more processing devices within the set of images, objects representing marine life in the marine environment 302 and classifying, by the one or more processing devices, the objects into multiple clusters based on feature vectors identified for each of the objects 303 can be combined into one step. The process 300 can also skip computing, by the one or more processing devices based on attributes associated with the multiple clusters, a metric indicative of the biodiversity in the marine environment 304 and instead output data from classifying, by the one or more processing devices, the objects into multiple clusters based on feature vectors identified for each of the objects 303.

A number of implementations have been described. Nevertheless, it will be understood that various modifications may be made without departing from the spirit and scope of the disclosure. For example, various forms of the flows shown above may be used, with operations re-ordered, added, or removed.

Implementations of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Implementations of the subject matter described in this specification can be implemented as one or more computer programs, i.e., one or more modules of computer program instructions encoded on a tangible non-transitory program carrier for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., LCD (liquid crystal display), OLED (organic light emitting diode) or other monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, e.g., a Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

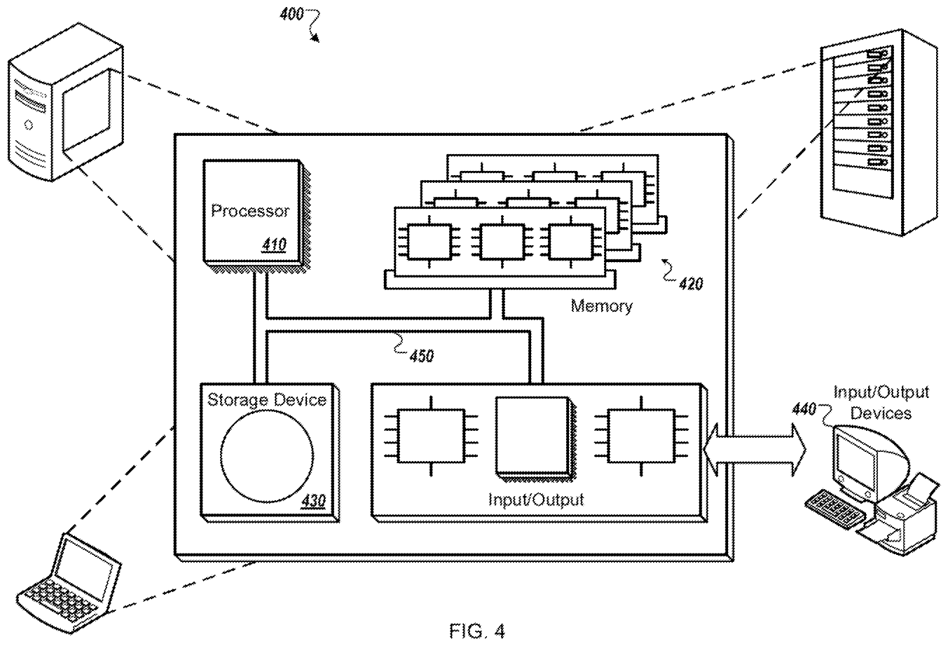

An example of one such type of computer is shown in FIG. 4, which shows a schematic diagram of a computer system 400. The system 400 can be used for the operations described in association with any of the computer-implemented methods described previously, according to one implementation. The system 400 includes a processor 410, a memory 420, a storage device 430, and an input/output device 440. Each of the components 410, 420, 430, and 440 are interconnected using a system bus 450. The processor 410 is capable of processing instructions for execution within the system 400. In one implementation, the processor 410 is a single-threaded processor. In another implementation, the processor 410 is a multi-threaded processor. The processor 410 is capable of processing instructions stored in the memory 420 or on the storage device 430 to display graphical information for a user interface on the input/output device 440.

The memory 420 stores information within the system 400. In one implementation, the memory 420 is a computer-readable medium. In one implementation, the memory 420 is a volatile memory unit. In another implementation, the memory 420 is a non-volatile memory unit.

The storage device 430 is capable of providing mass storage for the system 400. In one implementation, the storage device 430 is a computer-readable medium. In various different implementations, the storage device 430 may be a floppy disk device, a hard disk device, an optical disk device, or a tape device.

The input/output device 440 provides input/output operations for the system 400. In one implementation, the input/output device 440 includes a keyboard and/or pointing device. In another implementation, the input/output device 440 includes a display unit for displaying graphical user interfaces.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular implementations of the invention have been described. Other implementations are within the scope of the following claims. For example, the operations recited in the claims, described in the specification, or depicted in the figures can be performed in a different order and still achieve desirable results. In some cases, multitasking and parallel processing may be advantageous.

What is claimed:

1. A method of estimating biodiversity in a marine environment, the method comprising:
receiving a set of images representing the marine environment;
identifying, by one or more processing devices within the set of images, objects representing marine life in the marine environment;
classifying, by the one or more processing devices, the objects into multiple clusters based on feature vectors identified for each of the objects; and
computing, by the one or more processing devices based on attributes associated with the multiple clusters, a metric indicative of the biodiversity in the marine environment.

2. The method of claim 1, wherein the set of images include images captured by a remotely operated vehicle.

3. The method of claim 1, wherein the set of images include hyperspectral images.

4. The method of claim 1, wherein the feature vectors include vectors of locally aggregated descriptors (VLADs) generated by processing representation of the objects by a convolutional neural network.

5. The method of claim 1, wherein the attributes associated with the multiple clusters include one or more of: a number of clusters, a distribution of the multiple clusters, a spread among the multiple clusters, and a spread within a particular cluster of the multiple clusters.

6. The method of claim 1, wherein the objects are classified into multiple clusters using a supervised machine learning model trained on a corpus of labeled data set identifying various forms of marine life.

7. The method of claim 1, wherein the metric represents differences among the multiple clusters as computed based on multiple dimensions within the feature vectors.

8. A system comprising one or more computers and one or more storage devices on which are stored instructions that are operable, when executed by the one or more computers, to cause the one or more computers to perform operations for estimating biodiversity in a marine environment comprising:
receiving a set of images representing the marine environment;
identifying, by one or more processing devices within the set of images, objects representing marine life in the marine environment;
classifying, by the one or more processing devices, the objects into multiple clusters based on feature vectors identified for each of the objects; and
computing, by the one or more processing devices based on attributes associated with the multiple clusters, a metric indicative of the biodiversity in the marine environment.

9. The system of claim 8, wherein the set of images include images captured by a remotely operated vehicle.

10. The system of claim 8, wherein the set of images include hyperspectral images.

11. The system of claim 8, wherein the feature vectors include vectors of locally aggregated descriptors (VLADs) generated by processing representation of the objects by a convolutional neural network.

12. The system of claim 8, wherein the attributes associated with the multiple clusters include one or more of: a number of clusters, a distribution of the multiple clusters, a spread among the multiple clusters, and a spread within a particular cluster of the multiple clusters.

13. The system of claim 8, wherein the objects are classified into multiple clusters using a supervised machine learning model trained on a corpus of labeled data set identifying various forms of marine life.

14. The system of claim 8, wherein the metric represents differences among the multiple clusters as computed based on multiple dimensions within the feature vectors.

15. One or more non-transitory computer storage media encoded with instructions that, when executed by one or more computers, cause the one or more computers to perform operations for estimating biodiversity in a marine environment comprising:
receiving a set of images representing the marine environment;
identifying, by one or more processing devices within the set of images, objects representing marine life in the marine environment;
classifying, by the one or more processing devices, the objects into multiple clusters based on feature vectors identified for each of the objects; and
computing, by the one or more processing devices based on attributes associated with the multiple clusters, a metric indicative of the biodiversity in the marine environment.

16. The computer storage media of claim 15, wherein the set of images include images captured by a remotely operated vehicle.

17. The computer storage media of claim 15, wherein the set of images include hyperspectral images.

18. The computer storage media of claim 15, wherein the feature vectors include vectors of locally aggregated descriptors (VLADs) generated by processing representation of the objects by a convolutional neural network.

19. The computer storage media of claim 15, wherein the attributes associated with the multiple clusters include one or more of: a number of clusters, a distribution of the multiple clusters, a spread among the multiple clusters, and a spread within a particular cluster of the multiple clusters.

20. The computer storage media of claim 15, wherein the objects are classified into multiple clusters using a supervised machine learning model trained on a corpus of labeled data set identifying various forms of marine life.
